(19) United States
(12) Patent Application Publication
(10) Pub. No.: US 2008/0189596 A1
(43) Pub. Date: Aug. 7, 2008

(54) METHOD AND SYSTEM FOR ADDING INTELLIGENT-GRAPHIC DISPLAY ELEMENTS TO A NON-INTELLIGENT-GRAPHIC DISPLAY

(75) Inventors: Brent L. Hadley, Kent, WA (US); Patrick J. Eames, Newcastle, WA (US); Susan C. Chew, Issaquah, WA (US)

Correspondence Address: LAW OFFICE OF DONALD D. MONDUL, 3060 BONSAI DRIVE, PLANO, TX, 75093, US

(73) Assignee: BOEING COMPANY A CORPORATION OF DELAWARE, Chicago, IL (US)

(21) Appl. No.: 11/669,063

(22) Filed: Jan. 30, 2007

(51) Int. Cl. G06F 17/00; G06T 11/20

(52) U.S. Cl. 715/211; 345/441

(57) ABSTRACT

A method for adding intelligent-graphic display elements to a non-intelligent-graphic display includes: (a) in no particular order: (1) generating a first data file containing a plurality of first display objects representing the non-intelligent-graphic display in a first data format; (2) providing a second data file containing a plurality of second display objects representing selected intelligent-graphic display elements in a second data format; and (3) providing an objects recognizer tool; the objects recognizer tool recognizing substantial correspondence between respective first display objects and respective selected second display objects; and (b) employing the objects recognizer tool with the first data file and the second data file to generate a resulting data file. The resulting data file includes a third plurality of display objects representing at least a portion of the non-intelligent-graphic display in the second format.

### BACKGROUND OF THE INVENTION

The present invention is directed to graphic drafting and design tools, and especially to intelligent-graphic drafting and design tools. Intelligent drafting and design tools permit providing links or other connection mechanisms between elements of a graphic display and other information. By way of example and not by way of limitation, an on-line intelligent-graphic display may be embodied in a drawing. Elements of the drawing may be color coded or otherwise highlighted to indicate availability of additional information relating to the highlighted drawing element. A user may, by way of further example and not by way of limitation, place a mouse cursor over the highlighted element of the drawing, click the mouse device and be linked directly to additional information relating to the highlighted area of the drawing. Additional information to which a link may be provided may include, by way of example and not by way of limitation, tables, drawings of related sub-systems, detailed descriptions of systems or parts or similar information related to the highlighted area of the drawing.

Many displays such as drawings are non-intelligent-graphic displays that are not equipped for providing a link or other connection mechanism to additional information. A capability for providing an intelligent-graphic feature for such non-intelligent-graphic displays or drawings may permit a display designer to efficiently impart significant information to a viewer that could not as easily be imparted without an intelligent-graphic feature.

It would be useful to have a method and system for adding intelligent-graphic elements to a non-intelligent-graphic display.

### SUMMARY OF THE INVENTION

A method for adding intelligent-graphic display elements to a non-intelligent-graphic display includes: (a) in no particular order: (1) generating a first data file containing a plurality of first display objects representing the non-intelligent-graphic display in a first data format; (2) providing a second data file containing a plurality of second display objects representing selected intelligent-graphic display elements in a second data format; and (3) providing an objects recognizer tool; the objects recognizer tool recognizing substantial correspondence between respective first display objects and respective selected second display objects; and (b) employing the objects recognizer tool with the first data file and the second data file to generate a resulting data file. The resulting data file includes a third plurality of display objects representing at least a portion of the non-intelligent-graphic display in the second format.

A system for generating an intelligent-graphic drawing representing a non-intelligent-graphic drawing includes: (a) a first drawing objects file including a first plurality of data elements in a first format representing a first plurality of drawing objects associated with the non-intelligent-graphic drawing; (b) a second drawing objects file including a second plurality of data elements in a second format representing a second plurality of drawing objects associated with intelligent-graphic drawing objects; (c) an objects recognizer tool coupled for accessing the first and second drawing objects files and configured for recognizing selected first drawing objects of the first plurality of drawing objects in a context of the second format. The objects recognizer tool operates with the first drawing objects file and the second drawing objects file to generate a resulting data file. The resulting data file includes a third plurality of drawing objects in the second format representing the non-intelligent-graphic drawing.

It is, therefore, a feature of the present invention to provide a method and system for adding intelligent-graphic elements to a non-intelligent-graphic display.

Further features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a schematic diagram illustrating operation of one embodiment of the system of the present invention.

FIG. 2 is a flow diagram illustrating one embodiment of the method of the present invention.

### DETAILED DESCRIPTION OF THE PREFERRED EMBODIMENT

An embodiment of the present invention may be described by way of example and not by way of limitation in the context of treating a non-intelligent-graphic CADD (Computer Aided Design and Drafting) drawing to present an intelligent-graphic resulting drawing that is amenable to providing links or other mechanisms to other information.

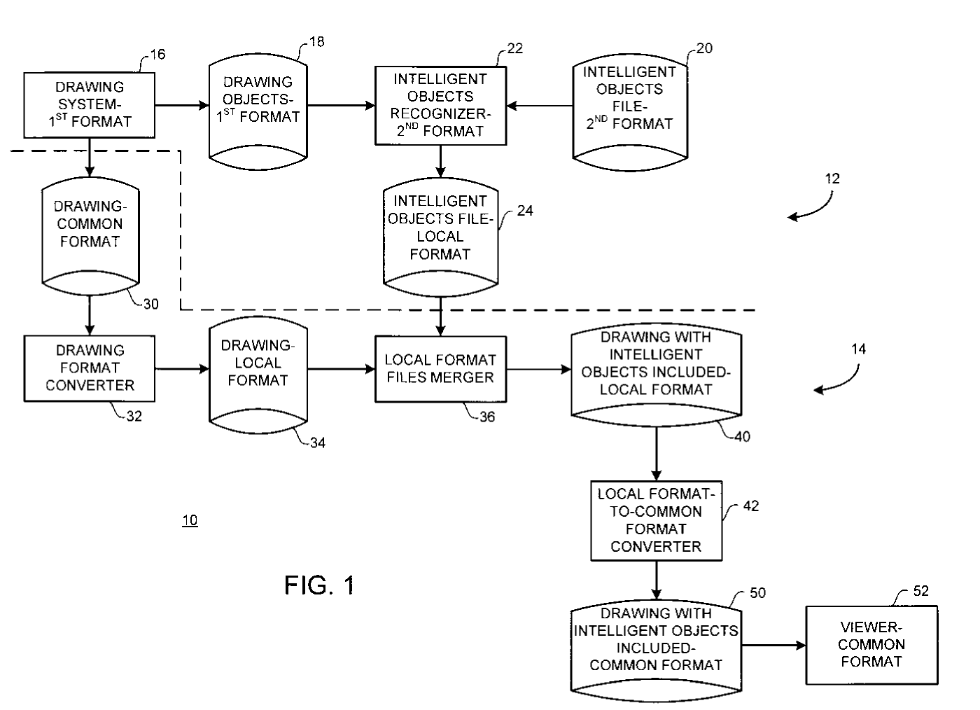

FIG. 1 is a schematic diagram illustrating operation of one embodiment of the system of the present invention. In FIG. 1, a system 10 for generating intelligent-graphic displays such as drawings includes a creation phase or section 12 and a verification phase or section 14. Creation section 12 includes a display originating unit or drawing system 16. Drawing system 16 generates a plurality of non-intelligent-graphic display or drawing objects in a first data format and stores the non-intelligent-graphic drawing objects in a first drawing objects store or file 18 expressed in the first data format. By way of example and not by way of limitation, drawing system 16 may be embodied in a CADD system configured for generating non-intelligent-graphic drawings.

This CADD embodiment of drawing system 16 will be employed in further explanations herein describing system 10 with the understanding that other display originating units may be employed within the scope of the present invention to create or generate non-intelligent-graphic displays including, by way of example and not by way of limitation, tables, electrical schematic diagrams, fluid system diagrams, mechanical system diagrams, organization charts, architectural drawings and other non-intelligent-graphic displays or drawings.

System 10 also includes a second drawing objects store or file 20. Second drawing objects file 20 includes a plurality of data elements representing intelligent-graphic drawing objects expressed in a second data format. System 10 further includes an objects recognizer tool 22 coupled with drawing objects files 18, 20. Objects recognizer tool 22 is preferably embodied in a software program configured for recognizing characteristics of first drawing elements stored or expressed in first objects store or file 18 in the first data format in a context of the second data format in which intelligent-drawing objects are stored or expressed in second objects file 20.

A drawing in a CADD drawing system may be represented as a set of drawing objects or data elements. By way of example and not by way of limitation, the following drawing elements in a CADD drawing system may be advantageously recognized by objects recognizer tool 22 by predetermined characteristics relating to identifiable drawing elements for use in the present invention:

| | |
|---|---|
| connect_node | Defines a point to which a nodal line endpoint |
| | is connected. |
| nodal_figure_instance | Defines position and parameters for nodal text |
| | entities. |
| nodal_line | Defines an entity that is a string that begins and |
| | ends at a connect node. |
| nodal_text | Contains text strings, text parameters, and |
| | association to principal nodal entity. |
| relation | Establishes a named, possibly directed |
| | relationship among a set of entities. |
| string | Defines a graphic construct with connected |
| | straight line segments. |
| subfigure_instance | Refers to a figure in the parts library so that it |
| | appears as replicated in the database. |
| text_node | Defines position and parameters for nodal text |
| | entities and represents bounded regions or |
| | polygons. |
| text | Contains text strings and text parameters. |

Wiring diagrams and system schematics built with a CADDS drawing system may be employed to cooperate in presenting drawing objects of interest to mechanics, engineers or other users but which are not readily discernible within the CADDS System. These logical objects may, by way of example and not by way of limitation, include:

| | |
|---|---|
| wire | An electrical wire. |
| wire bundle | Wires that are bundled together. |
| connector | Electrical component found at the end of a wire (e.g., |
| | circuit breaker). |
| socket | Found inside a connector; a single wire's connection point. |
| shield | Electromagnetic shield. |
| text | A label. |
| pipe | A flow inside a pipe. |
| region | A region marked by cross-hatches or outlined by lines. |

The process by which objects recognizer tool 22 proceeds in recognizing drawing objects or elements is not an object recognition process as that process is understood generally in the art. In contrast, objects recognizer tool 22 examines a first drawing objects file 18 containing data elements (such as drawing elements in a CADD file). Objects recognizer tool 22 examines the nature of the object represented by the data element (or data elements), examines the function of the object represented by the data element (or data elements) and examines where in the drawing the object is situated with respect to other objects in the drawing. As a drawing is examined and “constructed”, system 10 may observe inter-object connections as a further element of examination to effect the required recognition process.

A CADD file is typically a vector-based file that may only reveal a collection of lines or loci. No indication may be presented in a CADD file as to presence of a “box”, a “wire” or another element. In contrast, system 10 applies object recognizer tool 22 to a CADD file to effect pattern recognition and apply predetermined rules to ascertain or distinguish shapes such as a “box” or a “wire”. By way of example and not by way of limitation, if a CADD data element file presents a collection of loci that define a linear figure having a certain width or thickness, system 10 may apply a predetermined rule of construction that identifies that collection of loci as a “wire”. System 10 may proceed from identifying a “wire” to ascertain to what drawing elements (described by CADD data elements) the “wire” is connected. Other predetermined rules of construction applied by system 10 may result in identifying a connection by the “wire” with a cable plug attached to an amplifier or a relay. In such manner, system 10 constructs a drawing represented by drawing elements stored in first drawing objects file in the first format.

Object recognizer tool 22 also recognizes appropriate drawing objects represented by drawing elements stored in second drawing objects file 20 in the second format. Object recognizer tool 22 substitutes recognized second-format drawing objects from second drawing objects file 20 for recognized drawing objects expressed in the first format according to first drawing objects stored in first drawing objects file 18. The second format provides intelligent-graphic drawing elements.

Object recognizer tool 22 generates an intelligent drawing objects store or file 24 containing drawing objects appropriate for producing a drawing containing intelligent-graphic drawing elements.

Verification section 14 effects producing a drawing expressed in common format drawing objects or data elements. Verification section 14 uses data elements stored by a store or file 30 in a common data element format. The common format may be, by way of example and not by way of limitation, a CGM drawing format. CGM (Computer Graphic Metafile) is an ISO (International Organization for Standardization) standard drawing format designed for widespread use. A drawing format converter unit 32 may be employed with common format drawing objects file 30 to generate a local format drawing objects store or file 34. A local format files merger unit 36 may be employed with local format drawing objects file 34 and intelligent drawing objects file 24 to generate local-format drawing objects for storage in a local-format intelligent-objects-included drawing objects store or file 40. The term “local format” refers to a drawing or display data format that may be used by a user's computer device that differs from a common CGM format.

Intelligent-objects-included drawing objects file 40 preferably contains intelligent-graphic drawing objects in a drawing format that may be human-reviewable so that a human may determine whether edits to the produced drawing are necessary.

A local format-to-common format converter unit 42 may treat local-format drawing objects stored in local-format intelligent-objects-included drawing objects store or file 40 to produce common-format drawing objects for storage in a common-format intelligent-objects-included drawing objects store or file 50. An exemplary common format may be a CGM format. Drawings represented by common-format drawing objects stored in common-format intelligent-objects-included drawing objects file 50 may be read in a drawing produced by a common format viewer unit 52, such as by way of example and not by way of limitation a CGM viewer.

System 10 may be configured to convert drawing objects expressed in the first format (stored in first drawing objects file 18) completely to intelligent-graphic drawing elements so that local-format drawing objects stored in local-format intelligent-objects-included drawing objects store or file 40 are expressed entirely in an intelligent-graphic format. Alternatively, system 10 may be configured to convert some, but not all, drawing objects expressed in the first format (stored in first drawing objects file 18) to intelligent-graphic drawing elements so that some of local-format drawing objects stored in local-format intelligent-objects-included drawing objects store or file 40 are expressed in an intelligent-graphic format, and some are expressed in a non-intelligent-graphic format.

As mentioned earlier herein, in FIG. 1 the term “local format” refers to a drawing or display data format that may be used by a user's computer device that differs from a common CGM format. If a user employs a common CGM format, processes required for conversion from a CGM format to a local format and back to a CGM format may be eliminated from FIG. 1. That is, by way of example and not by way of limitation, when only a common CGM format is used, processes represented by elements 32, 34, 40, 42 may be eliminated and files merger may be performed by a unit represented by element 36 to generate common-format drawing objects (e.g., in CGM format) for storage in a common-format intelligent-objects-included drawing objects store or file 50.

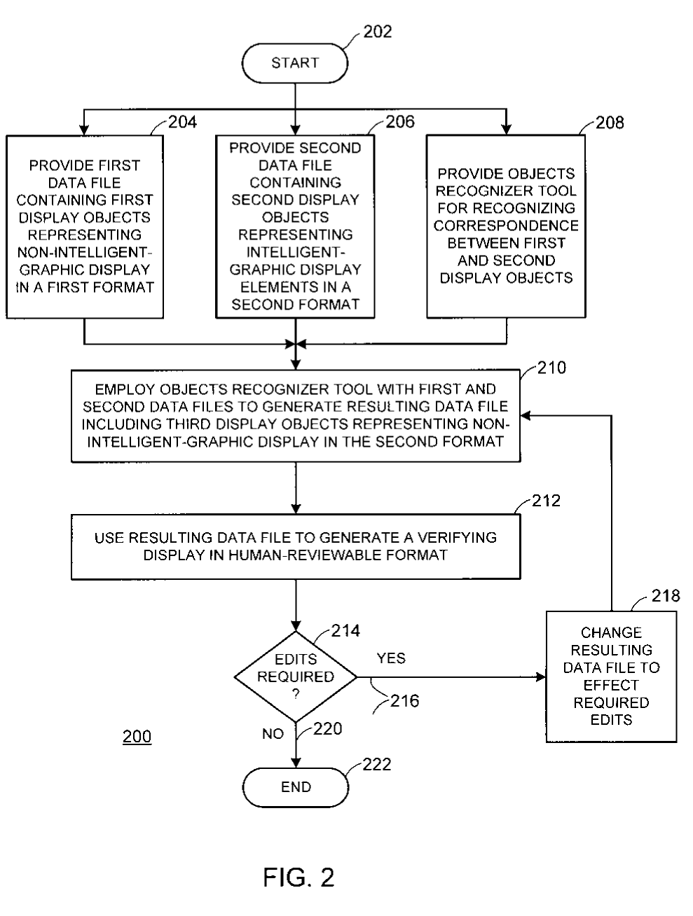

FIG. 2 is a flow diagram illustrating the method of the present invention. In FIG. 2, a method 200 for adding intelligent-graphic display elements to a non-intelligent-graphic display begins at a START locus 202. Method 200 continues with, in no particular order: (1) generating a first data file containing a plurality of first display objects representing the non-intelligent-graphic display in a first data format, as indicated by a block 204; (2) providing a second data file containing a plurality of second display objects representing selected intelligent-graphic display elements in a second data format, as indicated by a block 206; and (3) providing an objects recognizer tool, as indicated by a block 208. The objects recognizer tool recognizes substantial correspondence between respective first display objects and respective selected second display objects.

Method 200 continues by employing the objects recognizer tool with the first data file and the second data file to generate a resulting data file, as indicated by a block 210. The resulting data file includes a third plurality of display objects. The third plurality of display objects represents at least a portion of the non-intelligent-graphic display in the second format.

Method 200 may continue by using the resulting data file to generate a verifying display in a human-reviewable format, as indicated by a block 212. Method 200 may continue by posing a query whether edits to the display are required, as indicated by a query block 214. If edits are required, method 200 proceeds from query block 214 via a YES response line 216. Changes to the resulting data file are entered to effect required edits, as indicated by a block 218. Method 200 returns from block 218 to block 210 and continues as described earlier herein in connection with blocks 212, 214.

If no edits are required, method 200 proceeds from query block 214 via a NO response line 220 and proceeds to an END locus 222, thereby terminating method 200.

Embodiments of the invention provide advantages. By way of example and not by way of limitation, in one embodiment, wiring and symbol definitions may be extracted from engineering drafted wiring and schematic diagrams using a meta representation format. As a beneficial result, intelligent diagrams and schematics may be provided. Embodiments of the present invention may provide a controlled environment in which to author wiring diagrams and system schematics. Embodiments of the present invention may produce objects that are easily accessible and manipulated. A beneficial result may be that a drawing may be manipulated through its underlying entities to extract meaningful information about the content of the drawing.

It is to be understood that, while the detailed drawings and specific examples given describe preferred embodiments of the invention, they are for the purpose of illustration only, that the system and method of the invention are not limited to the precise details and conditions disclosed and that various changes may be made therein without departing from the spirit of the invention which is defined by the following claims:

We claim:

1. A method for generating an intelligent-graphic drawing representing a non-intelligent-graphic drawing; the method comprising:
(a) generating a first drawing objects file including a first plurality of data elements in a first format representing a first plurality of drawing objects associated with said non-intelligent-graphic drawing;
(b) providing a second drawing objects file including a second plurality of data elements in a second format representing a second plurality of drawing objects associated with intelligent-graphic drawing objects;
(c) providing an objects recognizer tool for recognizing selected first drawing objects of said first plurality of drawing objects in a context of said second format; and
(d) employing said objects recognizer tool with said first drawing objects file and said second drawing objects file to generate a resulting data file; said resulting data file including a third plurality of drawing objects in said second format representing said non-intelligent-graphic drawing.

2. A method for generating an intelligent-graphic drawing representing a non-intelligent-graphic drawing as recited in claim 1 wherein the method further comprises:
(e) using said resulting data file to generate a verifying drawing in a human-reviewable format.

3. A method for generating an intelligent-graphic drawing representing a non-intelligent-graphic drawing as recited in claim 1 wherein said first format is a computer-aided drafting format.

4. A method for generating an intelligent-graphic drawing representing a non-intelligent-graphic drawing as recited in claim 1 wherein said recognizer tool is embodied in a software program; said software program being executed using a computer device in cooperation with said first and second drawing object files for effecting said recognizing.

5. A method for generating an intelligent-graphic drawing representing a non-intelligent-graphic drawing as recited in claim 2 wherein the method further comprises:
(f) if edits to said verifying drawing are required, entering changes to said resulting data file to effect required edits using said second format; and
(g) if no edits to said verifying drawing are required, terminating the method.

6. A method for generating an intelligent-graphic drawing representing a non-intelligent-graphic drawing as recited in claim 5 wherein said recognizer tool is embodied in a software program; said software program being executed using a computer device in cooperation with said first and second drawing object files for effecting said recognizing.

7. A method for generating an intelligent-graphic drawing representing a non-intelligent-graphic drawing as recited in claim 3 wherein said recognizer tool is embodied in a software program; said software program being executed using a computer device in cooperation with said first and second drawing object files for effecting said recognizing.

8. A method for adding intelligent-graphic display elements to a non-intelligent-graphic display; the method comprising:
(a) in no particular order:
(1) generating a first data file containing a plurality of first display objects representing said non-intelligent-graphic display in a first data format;
(2) providing a second data file containing a plurality of second display objects representing selected intelligent-graphic display elements in a second data format; and
(3) providing an objects recognizer tool; said objects recognizer tool recognizing substantial correspondence between respective said first display objects and respective said selected second display objects; and
(b) employing said objects recognizer tool with said first data file and said second data file to generate a resulting data file; said resulting data file including a third plurality of display objects; said third plurality of display objects representing at least a portion of said non-intelligent-graphic display in said second format.

9. A method for adding intelligent-graphic display elements to a non-intelligent-graphic display as recited in claim 8 wherein the method further comprises:
(e) using said resulting data file to generate a verifying display in a human-reviewable format.

10. A method for adding intelligent-graphic display elements to a non-intelligent-graphic display as recited in claim 8 wherein said first format is a computer-aided drafting format.

11. A method for adding intelligent-graphic display elements to a non-intelligent-graphic display as recited in claim 8 wherein said recognizer tool is embodied in a software program; said software program being executed using a computer device in cooperation with said first and second data files for effecting said recognizing.

12. A method for adding intelligent-graphic display elements to a non-intelligent-graphic display as recited in claim 9 wherein the method further comprises:
(f) if edits to said verifying display are required, entering changes to said resulting data file to effect required edits; and
(g) if no edits to said verifying display are required, terminating the method.

13. A method for adding intelligent-graphic display elements to a non-intelligent-graphic display as recited in claim 10 wherein said recognizer tool is embodied in a software program; said software program being executed using a computer device in cooperation with said first and second data files for effecting said recognizing.

14. A method for adding intelligent-graphic display elements to a non-intelligent-graphic display as recited in claim 12 wherein said recognizer tool is embodied in a software program; said software program being executed using a computer device in cooperation with said first and second data files for effecting said recognizing.

15. A system for generating an intelligent-graphic drawing representing a non-intelligent-graphic drawing; the system comprising:
(a) a first drawing objects file including a first plurality of data elements in a first format representing a first plurality of drawing objects associated with said non-intelligent-graphic drawing;
(b) a second drawing objects file including a second plurality of data elements in a second format representing a second plurality of drawing objects associated with intelligent-graphic drawing objects;
(c) an objects recognizer tool coupled for accessing said first and second drawing objects files and configured for recognizing selected first drawing objects of said first plurality of drawing objects in a context of said second format; said objects recognizer tool operating with said first drawing objects file and said second drawing objects file to generate a resulting data file; said resulting data file including a third plurality of drawing objects in said second format representing said non-intelligent-graphic drawing.

16. A system for generating an intelligent-graphic drawing representing a non-intelligent-graphic drawing as recited in claim 15 wherein the system further comprises:
(d) a drawing generator device coupled for receiving said resulting data file;
said drawing generator device employing said resulting data file for generating a verifying drawing in a human-reviewable format.

17. A system for generating an intelligent-graphic drawing representing a non-intelligent-graphic drawing as recited in claim 15 wherein said first format is a computer-aided drafting format.

18. A system for generating an intelligent-graphic drawing representing a non-intelligent-graphic drawing as recited in claim 15 wherein said recognizer tool is embodied in a software program coupled with a computer device; said software program being executed using said computer device in cooperation with said first and second drawing object files for effecting said recognizing.

19. A system for generating an intelligent-graphic drawing representing a non-intelligent-graphic drawing as recited in claim 16 wherein the system further comprises:
(f) an editing device coupled with at least one of said drawing generator device and said drawing generator device; said editing device effecting changes to said resulting data file to effect required edits using said second format.

20. A system for generating an intelligent-graphic drawing representing a non-intelligent-graphic drawing as recited in claim 19 wherein said recognizer tool is embodied in a software program coupled with a computer device; said software program being executed using said computer device in cooperation with said first and second drawing object files for effecting said recognizing.
